(19) United States
(12) Patent Application Publication
(10) Pub. No.: US 2008/0229392 A1
(43) Pub. Date: Sep. 18, 2008

(54) SYMBIOTIC HOST AUTHENTICATION AND/OR IDENTIFICATION

(76) Inventor: Thomas Lynch, Galveston, TX (US)

Correspondence Address: OMIKRON IP LAW GROUP, 16325 BOONES FERRY ROAD , SUITE 105, LAKE OSWEGO, OR, 97035, US

(21) Appl. No.: 11/685,671

(22) Filed: Mar. 13, 2007

(51) Int. Cl. H04L 9/32

(52) U.S. Cl. 726/4

(57) ABSTRACT

Embodiments of identifying and/or authenticating membership in a symbiotic network are disclosed.

### BACKGROUND

This disclosure relates to host authentication and/or identification with respect to a symbiotic network.

Identifying and/or authenticating remote devices seeking access to computing resources is challenging. For example, on the Internet a protocol, such as Reverse Address Resolution Protocol, may be employed to back-track a message in an attempt to identify and authenticate a remote computing device originating a message. However, this protocol is limited in that it can only trace backwards to the last hop in what may be a many-hop line of communication. A need for more advanced methods of identifying and/or authenticating remote devices part of a common network is desirable.

### BRIEF DESCRIPTION OF THE DRAWINGS

Subject matter is particularly pointed out and distinctly claimed in the concluding portion of the specification. Claimed subject matter, however, both as to organization and method of operation, together with objects, features, and advantages thereof, may best be understood by reference to the following detailed description if read with the accompanying drawings in which:

FIG. 1 is a schematic diagram illustrating an embodiment of a symbiotic computing system.

FIG. 2 is a schematic diagram of an embodiment of an alternative symbiotic computing system.

FIG. 3 is a flowchart depicting an embodiment of a forward identification method.

FIG. 4 is a flow chart depicting an embodiment of a reverse identification method.

FIG. 5 is a dataflow diagram illustrating a difference between the embodiments of FIGS. 3 and 4.

FIG. 6 is a table showing an embodiment of test and alias vectors.

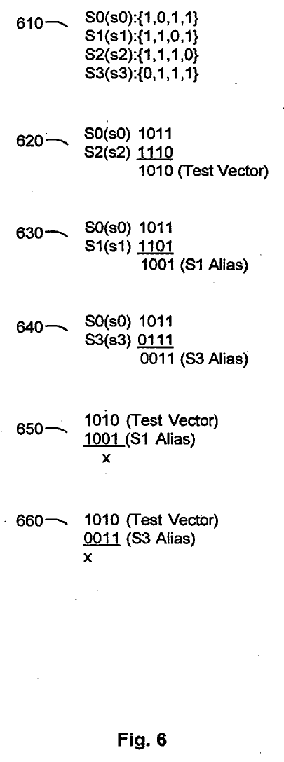

FIG. 7 is a block diagram illustrating various embodiments of symbiotic relationships.

FIG. 8 is a directed graph illustrating another embodiment of a symbiotic network.

### DETAILED DESCRIPTION

In the following detailed description, numerous specific details are set forth in order to provide a thorough understanding of claimed subject matter. However, it will be understood by those skilled in the art that claimed subject matter may be practiced without these specific details. In other instances, well-known methods, procedures, and components have not been described in detail so as not to obscure claimed subject matter.

Unless specifically stated otherwise, as apparent from the following discussion, it is appreciated that throughout this specification a computing platform includes, but is not limited to, a device such as a computer or a similar electronic computing device, that manipulates and/or transforms data represented as physical, electronic and/or magnetic quantities and/or other physical quantities within the computing platform's processors, memories, registers, and/or other information storage, transmission, reception and/or display devices. Accordingly, a computing platform refers to a system, a device, and/or a logical construct that includes the ability to process and/or store data in the form of signals. Thus, a computing platform, in this context, may comprise hardware, software, firmware and/or any combination thereof. Where it is described that a user instruct a computing platform to perform a certain action it is understood that instruct may mean to direct or cause to perform a task as a result of a selection or action by a user. A user may, for example, instruct a computing platform to embark upon a course of action via an indication of a selection, including, for example, pushing a key, clicking a mouse, maneuvering a pointer, touching a touch screen, and/or by audible sounds. A user may include an end-user.

Flowcharts, also referred to as flow diagrams by some, are used in some figures herein to illustrate certain aspects of some embodiments. Logic they illustrate is not intended to be exhaustive of any, all, or even most possibilities. Their purpose is to help facilitate an understanding of this disclosure with regard to the particular matters disclosed herein. To this end, many well known techniques and design choices are not repeated herein so as not to obscure the teachings of this disclosure.

Throughout this specification, the term system may, depending at least in part upon the particular context, be understood to include any method, process, apparatus, and/or other patentable subject matter that implements the subject matter disclosed herein.

Identifying and/or authenticating remote devices seeking access to computing resources is challenging. For example, on the Internet a protocol, such as Reverse Address Resolution Protocol, may be employed to back-track a message in an attempt to identify and authenticate a remote computing device originating a message. However, this protocol is limited in that it can only trace backwards to the last hop in what may be a many-hop line of communication. A need for more advanced methods of identifying and/or authenticating remote devices part of a common network is desirable.

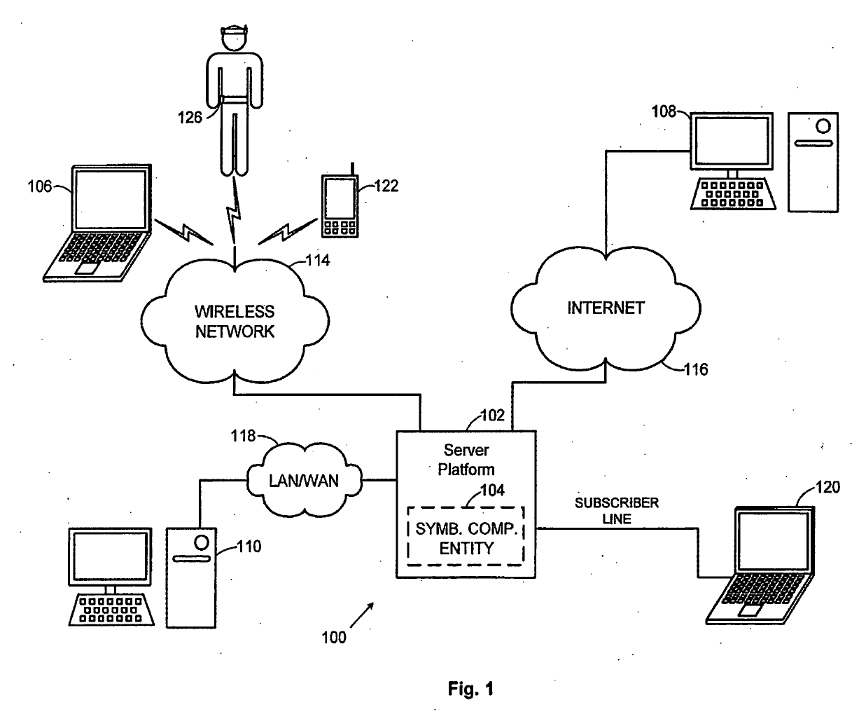

FIG. 1 is a schematic diagram illustrating an embodiment of a symbiotic computing system. In the embodiment depicted, a network of computing platforms may be implemented as described, for example, in U.S. Pat. No. 6,931,430; Maintaining Coherency in a Symbiotic Computing System and Method of Operation Thereof; by Thomas W. Lynch; filed May 12, 1999, and, without limitation, be employed or adapted to implement identification and/or authentication in a symbiotic computing system. A symbiotic computing system, such as 100, may include a plurality of computing platforms, any or all of which may reside physically near and/or apart from the other computing platforms. A symbiotic computing system may include a computing platform, such as a server platform, as shown by way of non-limiting example at 102, laptop computing platforms, such as 106 and 120, desktop computing platforms, such as 108 and 110, a wearable computing platform, such as 126, and a hand-held computing platform, such as 122, to name but a few of the many possibilities. Computing platforms 102, 106, 108, 110, 120, 122 and 126 may couple to and/or otherwise network with any or all of the other computing platforms via various communication links now known or to be later developed. A symbiotic computing system illustrated by 100 may be commonly referred to by some as a client/server system, although the scope of claimed subject matter is not limited in this respect. For example, other systems in addition to client/server systems may comprise symbiotic networks. However, in such a client/server system, a server platform, such as 102, may, for example, provide server operations to the other computing platforms which may operate as clients. Server operations may include, but are not limited to, serving as a repository for some and/or all of the data for a network. Similarly, server platform 102 may perform in a manner commonly associated with a gateway. For example, it may pass operations between members of a symbiotic network without intervention. In such a role, server platform 102 may be termed a symbiotic gateway. Server platform 102 may, by way of non-limiting example, provide file storage functions, communication and/or broadcast functions, database functions, and/or various other functions typically provided by a server, though the scope of claimed subject matter is not limited to these examples. A computing platform such as a server platform as shown by way of non-limiting example at 102 may also perform network management functions, including, but not limited to, managing the resources of one or more associated client computing platforms.

Communication links, such as those illustrated, for example, may have their own characteristics. For example, laptop computing platform 106, wearable computing platform 126 and hand-held computing platform 122, may couple to a computing platform such as server platform 102, which may itself comprise a network of computing platforms, for example. Although, the scope of the subject matter disclosed herein is not limited in this regard. Coupling may occur through a medium such as via a wireless network 114, however, claimed subject matter is not limited in scope to wireless coupling. Nonetheless, a wireless network, such as 114, may allow laptop computing platform 106, wearable computing platform 126, and hand-held computing platform 122, to be mobile, yet maintain relatively low bandwidth communications with a server platform, such as 102. Further, a desktop computing platform, such as 108, may couple to server platform 102 via a communications medium, such as the Internet, shown as 116. Similarly, desktop computing platform 110 may couple to a server platform, such as 102, via a Local Area Network (LAN) and/or a Wide Area Network (WAN). Internet 116 and a LAN/WAN, such as 118, may provide relatively higher bandwidth connections but may also provide little or no mobility benefits. Moreover, laptop computing platform 120 may couple to server platform 102 and/or any other computing platform capable of providing server-like operations. For example, this may be accomplished via a subscriber line, such as, for example, an Integrated Services Digital Network (ISDN), Asynchronous Digital Subscriber Line (ADSL) or Plain Old Telephone Service (POTS) line, although, again, the scope of claimed subject matter is not limited to these examples.

The computing platforms in the depicted embodiment may have resident thereupon a symbiotic computing entity. While a symbiotic computing entity, such as 104, is shown resident upon 102, symbiotic computing entities may also be resident upon 106, 108, 110, 120, 122, and 126, but are not explicitly shown in FIG. 1. As explained herein, the symbiotic computing entities may be executed via instructions, such as software instructions, upon available or modified hardware components and/or by customized hardware components, although the subject matter claimed is not limited in this respect.

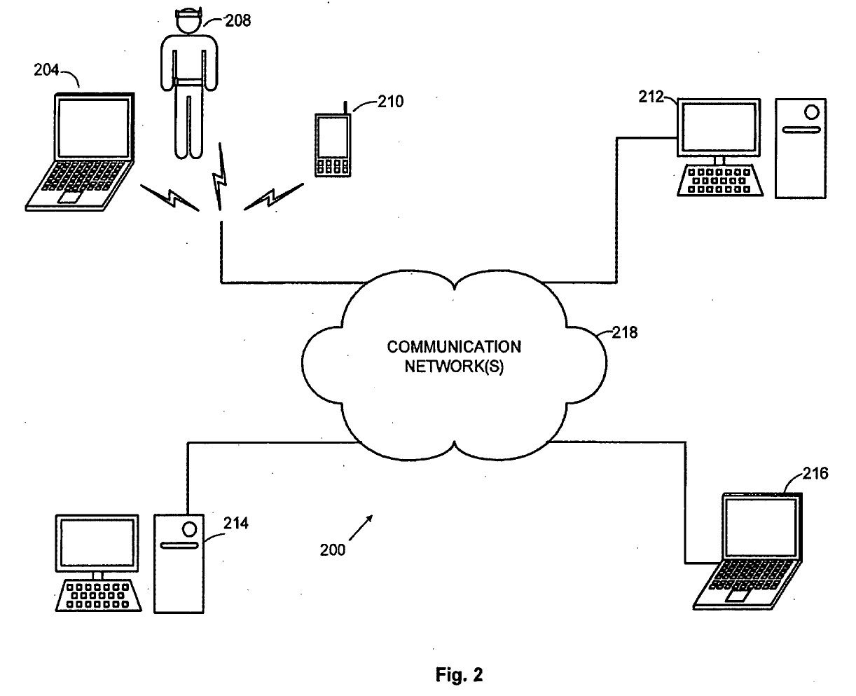

FIG. 2 is a schematic diagram of an embodiment of an alternative symbiotic computing system. As compared to system 100 of FIG. 1, the symbiotic computing system, shown at 200, does not include a server platform such as that depicted by FIG. 102. Thus, in system 200, symbiotic relationships may be established between peer computing platforms to maintain coherency of managed resources that may be included on one or more of the peer computing platforms. Such peer computing platforms may include, by way of non-limiting example, laptop computing platforms, such as 204 and 216, desktop computing platforms, such as 212 and 214, a wearable computing platform, such as 208, and a hand-held computing platform, such as 210. Peer computing platforms such as 204, 216, 212, 214, 208 and 210 may communicatively couple to one or more communication network(s), such as for example, 218.

Symbiotic relationships may be established amongst symbiotic partners comprising a symbiotic computing system to, at least in part, perform a symbiotic operation, as described in more detail hereinafter. Generally, a computing platform purporting to be a symbiotic partner may attempt to initiate a symbiotic computing session with an established symbiotic computing platform. A purported symbiotic computing platform may also be referred to as a requester, initiator, originator, and/or external computing platform. These terms are intended to be used interchangeably. Likewise, an established symbiotic computing platform may identify, and/or authenticate, for example, the requester as a legitimate symbiotic partner, also referred to herein more simply as a symbiotic partner. A computing platform being asked to, for example, authenticate a purported symbiotic partner may be termed herein, by way of non-limiting example, as an established or known symbiotic computing platform, network member, or symbiotic partner. A requestor may be considered remote as to a challenger but need not be. Further, as the computing platform being asked to grant a connection to a requesting system, an established symbiotic computing platform, may for example, in a role as a challenger, transmit to a requester, a challenge designed to, at least in part, establish the request as a symbiotic partner to the challenger. A challenge may comprise, though is not limited to, a query to generate a response from a requester.

An example of such a query may include, though is not limited to, confirming or verifying data in a symbiotic dataset shared by the symbiotic computing platforms. Further, a challenge may comprise, but again, is not limited to, a query phrased as a operation to be performed by a requester with the results of performing the operation, for example, on a symbiotic dataset, being returned for identification and/or authentication purposes. An example may include, but is not limited to, providing the results of applying a hash operation to the symbiotic dataset and reporting the result. If the result that is reported if verified, a challenger may accept a requestor as a symbiotic partner and the two computing platforms may establish a symbiotic relationship so as to perform one or more symbiotic operations. A collection of symbiotic computing platforms working as symbiotic partners may be termed a symbiotic computing system and/or a symbiotic computing network or more simply a symbiotic system and/or symbiotic network, although the scope of claimed subject matter is not limited in this respect.

As previously mentioned, a symbiotic computing system may include a plurality of symbiotic partners that may be communicatively coupled. A symbiotic partner may be employed to, for example, manage a data resource, as described in more detail hereinafter. A managed data resource may include, but is not limited to, data entities, such as data files, data bases, data sets, configuration files and/or source files, for example. However, a managed resource may also include other types of data resources such as, by way of non-limiting example, video images, symbiotic relationship configurations, applications, executables and other data resources. The contents and organization of a data resource at a particular point is referred to as an instance or instantiation of the particular data resource at that point. Alterations made to an instance of a managed data resource may be made to other instances of the managed data resource to, for example, maintain coherency between instances or instantiations.

A symbiotic partner may, for example, implement management of a resource via a symbiotic computing entity. As will be discussed more fully below, one or more symbiotic partners may, for example, receive data or other information that potentially affects a respective instance of a managed data resource. A symbiotic partner may, for example, produce an action based, at least in part, upon the received data or information. For example, such an action may result in modification of the particular instance of the managed data resource. Such an action may thus be transmitted to a symbiotic partner and converted locally to a command and thereby affect a local instance of a managed resource. A symbiotic computing platform may also package and transmit an action to another of the symbiotic partners. Another of the symbiotic partners may thus receive the action, convert it to a command consistent with the local resources, and use the command to affect a respective instance of the managed resource to, for example, maintain coherency of the managed data resource, although claimed subject matter is not limited in scope in this respect. Thus, actions may, for example, be used to transmit changes to a managed data resource and/or transmit operations that give rise to changes.

If establishing a symbiotic relationship amongst symbiotic partners, managed resources may be synchronized to at least in part, by way of non-example, ensure that a common starting point exists. From a common starting point, an instance of a managed data resource may be processed or changed based at least part, for example, on application of a program or by a user. Actions to be applied to a symbiotic partner may, for example, be generated from user inputs or from a program, for example, to be applied to another symbiotic partner, although the scope of claimed subject matter is not limited in this respect. Such actions, for example, may be converted to commands that may be received by an application program which may thus be used to operate upon a managed resource, although, again, the scope of claimed subject matter is not limited in this respect.

Generally, actions pass between symbiotic partners to maintain a managed resource and passing actions may maintain the symbiotic relationship, and thus enhance data security. Further, symbiotic actions may enhance data security. For example, assuming for the purposes of discussion, that an action is snooped and/or intercepted, the action alone is not sufficient to reconstruct the managed data resource, for example. Further, because coherent versions of a managed data resource may reside upon multiple symbiotic partners, data availability and/or data reliability may also be enhanced.

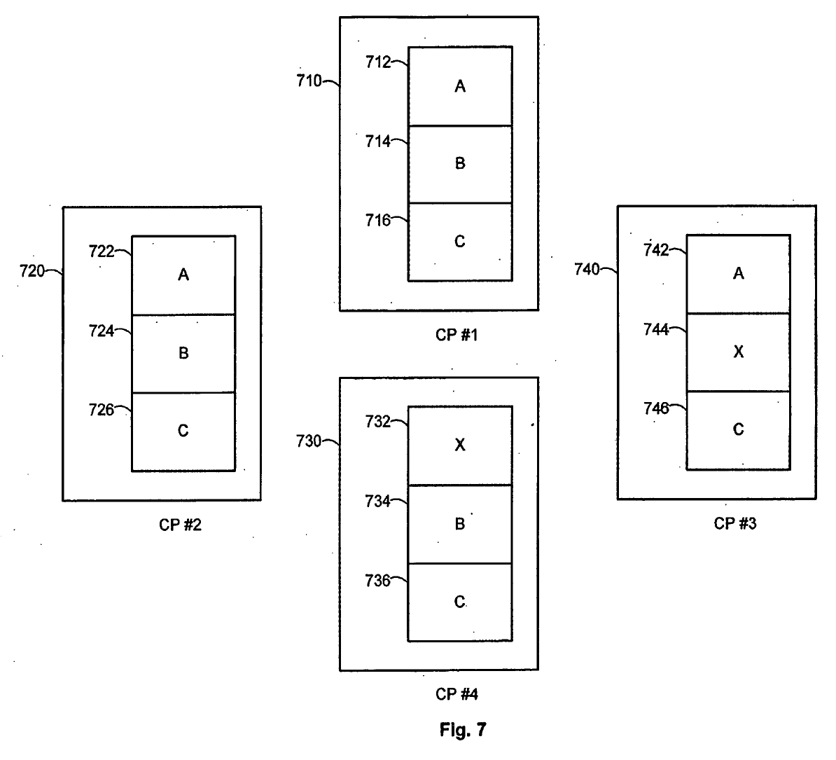

FIG. 7 is a block diagram illustrating various embodiments of symbiotic relationships. For example, systems 710, 720, 730, and 740 may hold one or more instances of a data managed resource. Managed data resources depicted herein as 710, 720, 730, and 740 may include, for example, Datasets-A, B, and/or C, although the scope of claimed subject matter is not limited in this respect. Further, the datasets may comprise data that may be unique to the members of a symbiotic relationship. By way of contrast, data that may not comprise symbiotic dataset may include an ASCII code chart and/or the windows operating system, for example. In other words, these are examples of data that one may expect to be resident on computing platforms that are not members of a symbiotic network, for example.

Symbiotic relationships may be symmetric or asymmetric. In a symmetric symbiotic relationship, actions may be created by both of a set of two symbiotic partners to affect a managed resource. Therefore, by way of non-limiting example, systems 710 and 720 may be mutually symmetric. Similarly, a symmetric symbiotic relationship may exist between system 710 and 740 at, for example, Dataset-A, such as at 712 and 742. Thus, an action applied to, for example, 712 by system 710 may be communicated to 742 as an action and system 740 may apply a similar action to 742, although the scope of claimed subject matter is not limited in this regard. Further, all of the systems depicted in FIG. 7 may be symmetric on, for example, Dataset-C, such as at 716, 726, 736, and 746. However, again, claimed subject matter is not constrained in this regard. Failure by any partner in, for example, a fully symmetric relationship may mean that the failed partner becomes unable to transmit or receive actions with respect to other of the symbiotic partners. Failure may include, but is not limited to, a communications channel being unavailable. Recovery from such failure may, depending on the particular embodiment, for example, be achieved in a variety of ways. For example, actions from a failed symbiotic partner may be buffered locally and transmitted after the partner recovers from the failure. Similarly, actions to be received by a failed partner may be buffered remotely and transmitted if recovery is verified. Alternatively, should failure continue beyond some threshold, for instance the tolling of a timer, the symbiotic partner may be flagged as removed or dropped from the symbiotic network until and unless some higher order of recovery may be implemented to assure a desired level of coherency, although claimed subject matter is not limited in this regard. Coherency amongst symbiotic partners may be re-established by resynchronizing managed resources as may be appropriate. Resynchronization may also be used if an instance of a managed resource becomes corrupted.

Time related management issues as they apply to coherency and corruption of a managed resource are well known in the relevant art. They include, for example, but are not limited to, received actions being applied to an instance of a managed resource according to their time stamps. Similarly, semaphores may be implemented so that one symbiotic partner may alter an instance of a managed resource at a time, although the scope of claimed subject matter is not constrained in this manner. Should inconsistencies appear between instances of a managed resource, a symbiotic computing platform may attempt to reconcile such inconsistencies. An attempt to reconcile apparent inconsistencies may include, but is not limited to, reordering actions with or without including undoing previous actions. Alternatively, and without limitation, a receiving partner may notify a sending partner of apparent or latent inconsistencies and request that the sending partner retransmit actions with or without reordering them, although the scope of claimed subject matter is not limited in this respect.

Coherency may be further enhanced by implementing a symbiosis validation entity and/or functionality. Such an entity and/or functionality may receive actions and attendant overhead information and evaluate whether or not coherency may be maintained on a local instance of a managed resource should a given action be implemented. Similarly, a coherency checking entity and/or functionality may be implemented that may verify coherency by using, for instance, CRC checks and/or checksums, though the scope of claimed subject matter is not limited to these examples.

FIG. 7 additionally depicts another embodiment. In an asymmetric symbiotic relationship, one of a set of two symbiotic partners, for example, may create actions that affects a managed data resource, although the other may not. An example of this includes, but is not limited to, if a computing platform such as system 710 may create actions affecting any of its managed resources on 720, but where its symbiotic partner, here, for example, system 720 may not be capable of applying or executing such actions. In an embodiment implementing this aspect, system 720 may, by way of non-limiting example, be used to shadow the managed resources of system 710 and provide for a coherently matched copy of these managed resources, here datasets A, B, and C. Similar to a symmetrical symbiotic relationship between systems at a given managed resource, as described above, an asymmetrical symbiotic relationship may exist between systems at the level of a single managed resource. For example, again system 710 may share a symbiotic partnership with system 740 at managed resources 712 and 742, respectively. However, in contrast to a symmetrical symbiotic partnership, they may have an asymmetrical symbiotic relationship such as where, for example, an action at 742 may change the resource and be communicated to 710; however, an action at 712 will affect neither 712 nor 742, however, claimed subject matter is not limited in scope in this regard. Additionally, in accordance with the forgoing, a symbiotic relationship may be established between multiple symbiotic partners having both symmetric and asymmetric components as to different instances of managed resources.

A symbiotic relationship may also be “minimal,” “partial,” or “full.” In a minimal symbiotic relationship managed resources occurs precisely twice in the network, while being resident on different machines. It is possible for a quite large network constituting many machines to be considered minimal from a symbiosis point of view. If no more than two machines are involved, it follows that the symbiotic relationship is minimal. A minimal symbiotic relationship exists, for example, between systems 710 and 720. A partial symbiotic relationship over a managed resource exists if there are more than two occurrences, but there are fewer occurrences than the number of symbiotic partners. A non-limiting example of such a network may include systems 710, 720, and 730, but not 740, although the scope of claimed subject matter is not limited in this regard. A full symbiotic relationship exists for a managed resource if all partners within a network include an occurrence of the managed resource. An example of this is illustrated by including all of the systems 710, 720, 730, and 740 illustrated in FIG. 7 in a symbiotic network. It is also possible for a symbiotic network to be less than minimal. However, some of the advantages of using symbiosis in such situations may be reduced. It is also possible for a symbiotic network to be more redundant than full. A symbiotic network may also comprise, for example, without limitation, a virtual and/or logical network where although some and/or all partners may be communicatively coupled to one or more of the others they may, nonetheless, share assigned and/or defined relationships. Further, any and/or all symbiotic relationships may, for example, be symmetric or asymmetric as previously described.

Further, a symbiotic relationship between symbiotic partners may be “pure” or “hybrid.” In a pure symbiotic relationship, actions may be passed between symbiotic partners, for example, without limitation, the actions operating via an application to affect a managed resource. In an embodiment, for example, system 740 and system 730 may comprise symbiotic partners at 746 and 736 respectively, which may comprise a dataset, although the scope of subject matter claimed is not constrained in this regard. Actions received at either may be communicated to and acted upon by the other. In a hybrid symbiotic relationship actions as well as other operations and/or exchanges may be passed between symbiotic partners. For example, system 730 and system 740 may communicate actions pertaining to a shared managed resource, such as 736 and 746 respectively, but they may also, without limitation, engage in other exchanges, such as, including without limitation, data updates, for instance. These operations and/or exchanges may further include, for example, file downloads and/or other transfers that may be initiated based at least in part upon user input but may be implemented in lieu of actions. Additional advantages of utilizing symbiotic actions include, but are not limited to, reducing network traffic by, for example, engaging in transactions employing less network traffic to implement than typical file transfers.

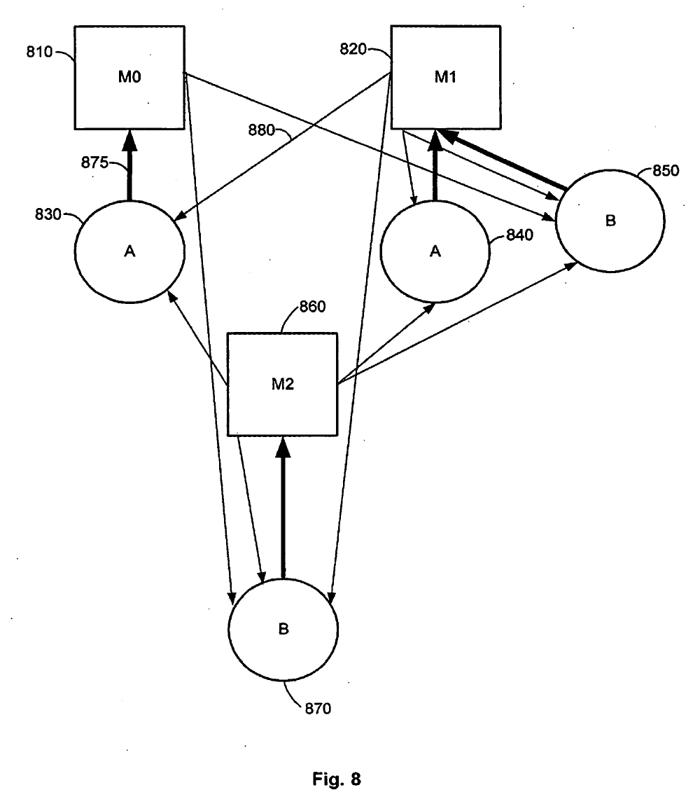

A symbiotic network may be described using a special form of directed graph such as that shown by FIG. 8. FIG. 8 depicts two types of nodes: machine nodes and managed resource nodes. The machine nodes, 80, 81, and 82; 810, 820, and 860 respectively, are shown as squares. Managed resource node “A,” depicted as separate instances 830 and 840; and managed resource node “B,” similarly depicted as separate instances 850 and 870 are shown as circles. FIG. 8 also depicts two types of arcs; locality arcs, and action flow arcs. If a managed resource is hosted locally on a machine, a locality arc, depicted in the figure as the thicker of the two illustrated arc styles, extends from the managed resource to a hosting machine. Such a relationship may be depicted, by way of non-limiting example, by locality arc 875 illustrating a relationship between a machine node such as 810 and a managed resource such as shown at 830. An instance of a managed resources may be given a name, for example “A” or “B.” If two managed resources are symbiotically identical, they may have the same name. Action flow arcs are depicted as extending from a machine node to a managed resource node if that machine can send actions that affect that managed resource. Where a managed resource is local to a given machine, that local machine may be able to mitigate the flow of actions to that managed resource. Two machines are said to have an asymmetric relationship, if they have resident an ostensibly matched managed resource, described above as managed resources that may share the same name, but do not both have action flows to the other's managed resource node. Machines 810 and 820 diagram a non-symmetric relationship on managed resource A. 820 may affect 810's managed resource A, such as shown at 840, and illustrated by arc 880. However, F80 cannot affect 820's managed resource A, such as shown at F40, and illustrated by the absence of an arc between 810 and 840. Similarly, 810 may have an asymmetric relationship with 860 over managed resource “B” depicted at 870. F80 can affect B's managed resource B, such as shown at 870, but 860 can not affect 810's managed resource B, as machine 80 shown at 810 does not have an instance of managed resource B. In this latter example, where 810 does not have an instance of managed resource B, we may call this special case ‘asymmetry without ownership.’ Note, in a well formed symbiotic networks, instances of an ostensibly same managed resource, such as those described above as managed resources that may share the same name, may be affected with actions from any given machine that may affect any one of them. It is understood throughout that instances of ostensibly the same managed resources comprise managed resources that are intended to be the same as each other. Such managed resources may not necessarily, however, be identical to each other at all moments at time such as if, by way of non-limiting example, an update has been affected at one copy of the managed resource but has not yet been affected at another copy of the managed resource.

Symbiotic computing may be established in any of many various network architectures or network configurations. For example, without limitation, a symbiotic computer system, for example, may reside within a client/server environment, or a peer-to-peer environment, as previously discussed, and/or in an object oriented environment, among others. Additionally, symbiotic computing may, for example, facilitate relatively low bandwidth management of resources by generally communicating actions, but not data.

In establishing symbiotic operation within a symbiotic computing system, synchronization among instances of a managed resource may be desirable. Symbiotic relationships may be defined such that data may be received by one or more of the symbiotic partners. After the relationships are defined, operations may continue to maintain coherency of instances of a managed resource. However, problems in operation caused by, for example, computer outages, software bugs, computer failures, network problems, inconsistent actions and/or any other problems may indicate that a problem exists with maintaining coherency. If such problems occur, checks may be performed to determine if the symbiotic computing system is operating properly. If not, recovery may be initiated so that instances of a managed resource may again become coherent. After this is completed, operation may continue. If inconsistent actions and/or problems occur, other techniques, some well known in the art, may also be employed to move forward in the operation of the symbiotic computing system without initiating a full recovery operation. Such techniques may modify a managed resource using a set of rules or by rejecting, for example, one or more inconsistent actions, though, again, claimed subject matter is not limited in scope in this respect.

In an embodiment, it may be useful to know, for example, that a message was sent by another member of the symbiotic computing network; though it may not be as important to know specifically which member sent the message. A member of a symbiotic network may be referred to, in some contexts, as a symbiotic partner, although claimed subject matter is not limited in scope in this respect. Resolving which computing devices comprise legitimate members of a symbiotic network may be referred to, for example, as resolving the membership predicate, although claimed subject matter is also not limited in this respect. Likewise, in an embodiment, symbiotic partners may, for example, share a symbiotic dataset. This may comprise, for example, minimal, partial, or full symbiosis. In this context, identification of a symbiotic partner may include, but is not limited to, an existing symbiotic system requesting a purported symbiotic system to provide information verifying its identity as a member of the symbiotic network or system. This may include, for example, a process whereby a computing platform matches a set of qualities or characteristics that uniquely identify another computing platform with those expected, for example, of the another computing platform.

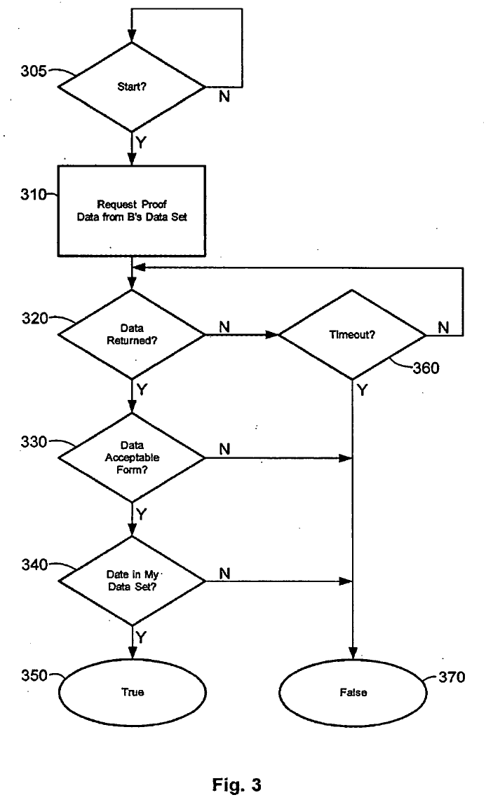

FIG. 3 is a flow chart depicting an embodiment of a forward identification method. Of course, claimed subject matter is not limited in scope to this particular embodiment. However, in the embodiment illustrated, an interaction may begin, such as at 305, for example, if, for example, a system requests to couple to a symbiotic network member. For the sake of discussion, we may refer to the system requesting to couple, as Sys-B, however, claimed subject matter is not limited in this respect. Similarly, we may, for example, for the sake of discussion, refer to the system evaluating the membership predicate, as Sys-A, although, again, claimed subject matter is not limited in scope in this respect.

As a first operation, Sys-A, may, for example, at 310, request that Sys-B send to Sys-A some part of Sys-B's dataset, for example, herein referred to as, Dataset-d. If Sys-B is a legitimate member of the symbiotic network, Sys-B may have a version of Dataset-d, for example, as may Sys-A, in this example. It may, therefore, be reasonable to expect Sys-B to return to Sys-A, Dataset-d. In the discussion herein, Dataset-d is understood to mean any portion, complete or partial, of any managed resource, including without limitation, results of any operations and/or calculations described herein, including any methods or processes of constructing and/or transmitting challenges. However, if Sys-B is not legitimately a member of the symbiotic network, Sys-B may fulfill the request without proper information. Sys-A may set a timer, such as illustrated at 360, to allow a finite window of time for Sys-B to respond. Should Sys-B fail to timely respond, Sys-A may interpret this in a manner similar to having received an invalid response, and may conclude that Sys-B is not a member of the symbiotic network and take appropriate action, such as at 370. Similarly, Sys-A may keep issuing challenges for a period of a duration managed at 360. Should Sys-B return a dataset purportedly from Dataset-d, such as at 320, Sys-A may evaluate the received dataset for proper form and/or content, such as at 330. If, for example, the dataset returned by Sys-B passes inspection or evaluation, Sys-A may evaluate contents of the received dataset to determine if it matches the content of Sys-A's version of Dataset-d. Sys-A may conclude, such as at A50, that Sys-B is ta symbiotic partner and legitimately a member of the symbiotic network. However, should Sys-B fail to properly return Dataset-d, as requested, Sys-A may conclude that Sys-B is, for example, is a spoofer and/or otherwise an imposter. Sys-A may initiate any sequence of subsequent measures including, for example, though not limited to, dropping the connection or coupling. Further, measures which Sys-A may undertake may range from nothing further or many further operations, and claimed subject matter is not limited in scope in this respect. Measures that may be undertaken by a system that detects another system illegitimately attempting to couple or connect to it are well known to those skilled in the art.

An example to demonstrate the operation of the embodiment described above, although claimed subject matter is not limited in scope to this example. Suppose, for the purposes of this example, that the above mentioned shared dataset includes seven items: <7; V; “fred;” 23; “a nice day;” 2343; and, 1 e-7>. For the purposes of this example, this dataset may be described as fully symbiotic on the network, which may mean that all members of the network have a version of the dataset. Systems not on the symbiotic network should not have a version of the dataset. Sys-B may request to connect/couple to Sys-A, as an example. In response, Sys-A may challenge Sys-B by requesting that Sys-B return any item from Dataset-d. Sys-B may select 23, for example, though claimed subject matter is not limited in this respect, and return the selected item, here 23, to Sys-A. Sys-A may check its own version of Dataset-d and find a match. This suggests to Sys-A that Sys-B is a symbiotic partner. If, however, Sys-B had returned an erroneous value, such as 47, for example, Sys-A may determine that there exists a likelihood that Sys-B is not symbiotic partner and, therefore, not a legitimate member of the network.

In alternative embodiments Sys-A may run the membership predicate by constructing the challenge to the requesting system, described above as Sys-B, by way of non-limiting example, using different parameters than simply requesting an item from a dataset. For example, Sys-A could request Sys-B to send the result of applying one or more functions or operations to Dataset-d or to part of Dataset-d.

Following is a list example functions suitable for incorporation into alternative embodiments in accordance with claimed subject matter, although these examples are not meant to be exclusive. In particular, but without limitation, operations may comprise logical and/or mathematical operations including a cyclic redundancy check and/or a hashing function. Similarly, alternative embodiments may, for example, challenge a requestor to perform multiple operations upon a dataset. Likewise, a challenge may be constructed in an alternative embodiment requesting a splatter pattern listing bit indexes in the dataset to be returned for verification. Still another embodiment may request a set of finite difference coefficients to a pattern generator for finding bit indexes be returned, though, again, claimed subject matter is not limited in scope to these described embodiments. A further embodiment may include returning pseudo randomly chosen bits scattered over a data set. If such data is transmitted, such data will not on its face provide meaningful information to a listener. If, for example, Dataset-d had clear text in it, as previously described, a listener might learn something from that clear text such that “23” is in the dataset. Eventually, if enough challenges were spied upon, the dataset may become known. By way of comparison, it is observed that, random bit selection is analogous to bit permutation which is often performed in various encryption techniques. Concomitantly, running data through a hashing function or sending a CRC similarly may make data less intelligible. By way of comparison, the reverse method of authentication may provide other advantages.

Further embodiments include, but are not limited to, issuing a challenge wherein the existing symbiotic network member, for example, Sys-A in the immediately preceding example, requests not just data and/or that operations be performed upon the data, but that the computing platform requesting a connection provide information about the data in the dataset. By way of non-limiting example, this may include, but is not limited to, requesting information about the position of data in the dataset. Data may for example, include, but is not limited to, not only the coding for data elements, such as ASCII coding, but also, without limitation, may include the data conveyed by any such coding such as, for example, the letter “a.” Furthermore, and/or alternatively, Sys-A may request time stamps associated with specified data, and/or request information relating at least in part to any of the properties and/or metadata associated with the data. As a further, non-limiting, possibility, metadata associated with data may specify that a function be evaluated and/or the function to be performed upon the data. Such operations or variations of such operations may be performed upon data and lend themselves to processes of identification and/or authentication if they can be reliably and verifiably performed on either end of a session. As will be apparent to those skilled in the art, any and/or all of the above may be implemented in an embodiment; however, claimed subject matter is not limited in this respect.

A further alternative embodiment may include a dataset and/or section of a dataset whose purpose, at least in part, may be for use in identifying a symbiotic partner. One benefit, among many, of such a dataset is that a non-symbiotic partner snooping and/or spying upon the network may not be aware of the value of such data, likely complicating efforts to illegitimately access the network and/or establish a link with a symbiotic partner. In an embodiment, identifying a system as either a symbiotic partner or an imposter may comprise uniquely identifying the identity of a computing platform and/or entity. Alternatively, in another embodiment identifying a computing platform as either a symbiotic partner or an imposter may comprise, without limitation, generally identifying a purported symbiotic partner generally as a symbiotic partner, but not specifically establishing its identity, that is, which specific symbiotic partner it is, as will be explained below.

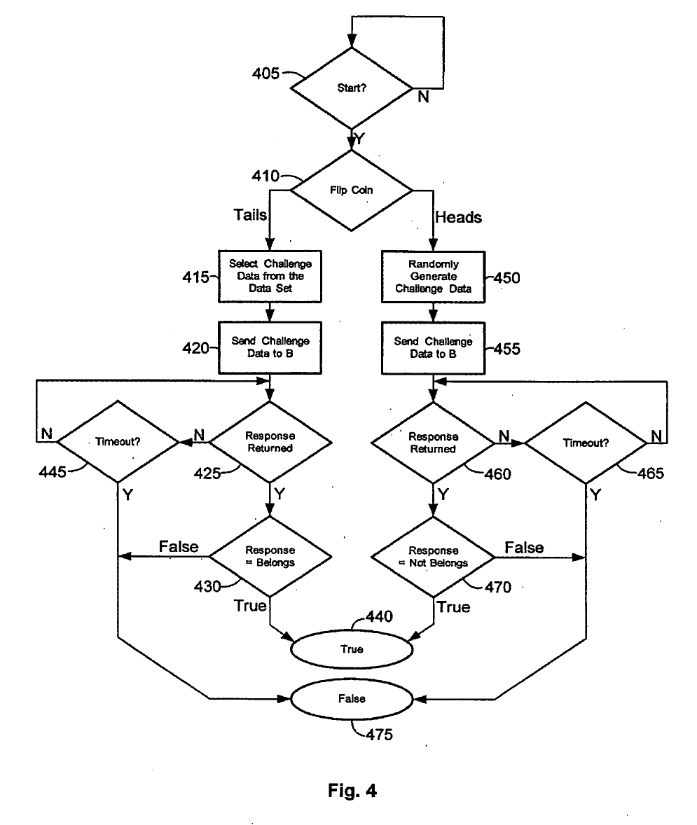

FIG. 4 is a flow chart depicting an embodiment of a reverse identification method. For the purposes of illustration, although claimed subject matter is not limited in this regard, we may again refer to the system requesting access and/or a connection as Sys-B; the system being asked to grant access and/or allow the connection as Sys-A; and, the symbiotic dataset Sys-B may have in common with Sys-A if Sys-B legitimately belongs the symbiotic network with Sys-A, as Dataset-d.

Sys-A may determine, such as at 405, to run a membership predicate against Sys-B, in a circumstance such as if, for example, Sys-B has asked Sys-A to allow Sys-B to connect or couple to Sys-A. In this embodiment, Sys-A may determine to run a reverse identification predicate against Sys-B. In the reverse method of identification, the existing network member, here by way of non-limiting illustration Sys-A, may, in an embodiment, transmit a data item, which may or may not be legitimately from Dataset-d, to the possible network member, here also by way of non-limiting illustration, Sys-B, and request Sys-B to verify whether or not the transmitted data does, indeed, belong in Dataset-d. In this embodiment, for purposes of challenging Sys-B, Sys-A may elect, such as at 410, to use data actually from a valid dataset as the basis of the challenge or alternatively may elect to use, for example, randomly generated data, such as at 450.

Accordingly, in one possible embodiment, Sys-A may elect, such as at 415, to select the challenge data from Dataset-d. Dataset-d may comprise a working dataset and/or a dataset, at least in part, dedicated to supporting challenges. Such data may be internally generated, or alternatively, for example, received from another system, and the scope of claimed subject matter is not limited in this respect. That Sys-A may randomly generate challenge data is shown at B₅₀. Sys-A may transmit the challenge, such as at 420, along with a query, express or implied, for example, regarding if the transmitted data is part of the dataset. Sys-B may respond, such as at 425, to the query with one of two outcomes, such as yes or no, although claimed subject matter is not limited in this respect. A timer, such as at 445, may also be used in an embodiment, such as at 445, to allow some finite amount of time in which Sys-B may return a valid response, as previously suggested. Otherwise a response to the query posed may be interpreted as a no or a false, for example. Again, the scope of claimed subject matter is not limited in this respect. Alternatively, and without limitation, failure to respond, such as at 445, may lead to Sys-A determining that Sys-B is not a legitimate member of the symbiotic network and mark either Sys-B as a false partner, and/or mark the response to the latest queries as false, for example at 475, and block a continued attempt to join with Sys-A by, for example, dropping the connection or coupling. Alternatively, Sys-A may continue to send Sys-B challenges but register a reduced likelihood that Sys-B is legitimately a symbiotic partner. Upon receipt of a response from Sys-B, Sys-A may evaluate, such as at 430, the response for correctness. Sys-A may, in an embodiment, compute a probability that Sys-B actually belongs on the network. In an embodiment, reverse challenges may be run in succession with results accumulated. A correct response may, for example, be accumulated through, for example, 440, while a false answer may similarly be accumulated, through for example, 475. By way of non-limiting example, should a series of 32 challenges be issued and answered correctly, there may be a 1 in 2̂32 probability that Sys-B is not a legitimate member of the network. Contrarily, if Sys-B should answer incorrectly at any point during this testing, Sys-B may be considered to not be legitimate and/or, by way of non-limiting example, the probability that Sys-B is a legitimate member of the symbiotic network, reduced.

In these contexts, authentication, may include, but is not limited to, determining a system's identity and may as well comprise determining what that system is authorized to do, such as for example, what that system is permitted to access, as a simple example. In an embodiment, a system may establish that it is a symbiotic partner, for example, with another system, as to a given dataset but that may not, necessarily, mean that after authenticated the system joining with the established symbiotic computing platform has unlimited privileges as to any of the established symbiotic partner's resources. In an embodiment, should a purported symbiotic partner be identified as a legitimate symbiotic partner but, for example, attempt operations on a symbiotic partner that exceed the permissions granted, such an attempt may, for example, trigger a system response similar to that encountered if an unknown or illegitimate computing platform attempts to connect or couple to an existing symbiotic computing platform. The process of authentication may comprise applying a set of rules. Authentication may be strengthened by establishing certain times at which authentication may be allowed to occur, although claimed subject matter is not limited in scope in this regard. The process of authentication may comprise authentication queries and/or challenges, for example.

Alternatively, at 410, Sys-A may have determined to construct a challenge by using some randomly generated, or otherwise known false data. Then, for example, at 455, Sys-A may transmit to Sys-B this invalid data. Sys-B may respond, such as at 460, to the challenge sent by Sys-A. Similar to what is described above, 460, 465, and 470 respectively, illustrate evaluation of a received response. Sys-A may wait for some period of time, such as illustrated at 465, for Sys-B to respond, as illustrated at 460, and failing a response submit an indication of a false or otherwise failing answer, as illustrated at 475. Similarly, and without limitation, timer 465, and for that matter also timer 425 and/or any other timers described herein, may be used to time a window for running challenges as possible. Should Sys-B return an answer in response to a challenge generated by Sys-A, Sys-A may evaluate the answer to determine if it is correct, as illustrated at 470. In this embodiment, Sys-A may for example determine that the response from Sys-B is improper, either in form and/or content, for example, and send an indication of false, such as at 475, to allow any of the many possible previously discussed system events to occur. An alternative embodiment may include functionality wherein if challenges are successfully met the receiving computing platform still terminates communications. In such an embodiment, a terminated channel may indicate an unreliable channel and/or a failed response, and/or neither thus introducing an additional layer of uncertainty to snooping. Alternatively, by way of non-limiting example, the evaluation indicated at 470 may signal a true condition and, similarly, allow some further system event to occur.

Embodiments are not limited to running membership predicates and/or issuing challenges once. Such actions may occur after some number of transactions, accesses, accesses of a certain class, and/or period of time, to name a few of the many possibilities. Further, in an embodiment, one symbiotic partner may be able to verify another symbiotic partner to a network, while in another embodiment, each symbiotic partner may have to verify itself to each symbiotic partner with which it interacts. However, the scope of claimed subject matter is not limited in this respect.

Similarly to a forward identification method, a reverse identification method may be strengthened by requesting Sys-B to provide data about the dataset and/or perform operations upon the dataset. Accordingly, it is intended that embodiments include any and/or all variations, permutations, and extensions of managed resources described herein.

For at least one embodiment, for example, a reverse identification method may be run for a fixed number of iterations. With such an embodiment, a system issuing the challenges, Sys-A in the preceding examples, may not necessarily cease issuing challenges after determining not to authenticate a possible symbiotic network member, Sys-B, in the preceding examples. A benefit, for example, of such operation includes not educating an imposter as to which response may be an incorrect response

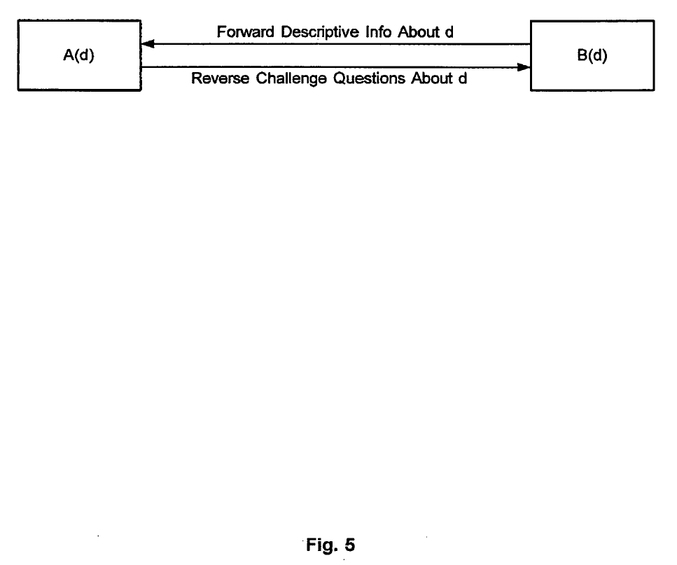

FIG. 5 is a data flow diagram illustrating differences between previously described embodiments. In this diagram, Sys-A, again, is the system being asked to recognize the membership of Sys-B. Similarly, again, Dataset-d comprises the dataset being used to identify and/or authenticate Sys-B. As illustrated by the diagram for a forward identification, Sys-A may apply a membership predicate to Sys-B by, for example, requesting that Sys-B return to Sys-A some portion of Dataset-d, in at least any one of the manners or approaches described herein. In contrast, if applying a membership predicate to Sys-B using a reverse identification method, Sys-A may send some portion of data purportedly from Dataset-d and request Sys-B to confirm or deny that the data legitimately belongs to Dataset-d.

Legitimate members of a symbiotic network may be referred to, in some embodiments, as symbiotic partners. A symbiotic partner may include some and/or all of a dataset included by another symbiotic partner. In another embodiment, a symbiotic partner may comprise a user account. In an embodiment, a user account may comprise an account established by a system administrator, for an individual user, on an individual machine. However, in at least one alternative embodiment, in keeping with claimed subject matter, for example, a user's account may be spread across some number of computing devices. An example of this may include a personal data assistant (PDA) including a user's list of personal contacts, while a desktop computer may include the user's business contacts, and a personal entertainment device (PED) may include a play list of the user's favorite songs. Collectively, in an embodiment, these may comprise an implied user account, which may be treated as a symbiotic partner.

In an embodiment, an implied user account may employ, for example, partial symbiosis. Partial symbiosis may be where datasets are fully or partially shared with a subset of symbiotic partners. In one embodiment, a symbiotic partner may include distinct unary partial symbiotic relationships with each of the symbiotic partners it may care to later identify. Similarly, these symbiotic partners may operate in a similar fashion. That a pair of symbiotic partners share a dataset or a partial dataset may not preclude them from having a full or partial symbiotic relationship on other datasets and/or parts of other datasets. As is the case with other symbiotic partners, an embodiment may use a forward identification method and/or a reverse identification method, depending, for example, upon the particular embodiment.

In one embodiment, a symbiotic partner, herein referred to as Sys-1 may have symbiotic partners Sys-2 and Sys-3, for example. They may have a partial, pair wise, symbiotic relationship with each other in that they may not each have a full version of the others' data. Perhaps, for purposes of illustration, for example, Sys-1 has a partial symbiotic relationship with Sys-2 and Sys-3; Sys-2 has a partial symbiotic relationship with Sys-1 and Sys-3; and, Sys-3 has a partial symbiotic relationship with Sys-1 and Sys-2. In a short-hand style, this may be denoted as: Sys-1 (12, 13, 21, 23), Sys-2 (21, 23, 13, 32), and Sys-3 (31, 32, 13, 23) wherein the first digit in a pair may denote a data generator and the second digit in a pair may denote a data destination, although claimed subject matter is not limited to any particular approach. Data generators may comprise all of the data that they have generated though this is not a requirement. As described in more detail below, this notation may allow one to reduce these systems to equivalent systems of symbiotic networks. Therefore, {Sys-1 (12), Sys-2 (12)}, {Sys-1 (21), Sys-2 (21)}, {Sys-1 (13), Sys-3 (12)}, {Sys-1 (31), Sys-3 (31)}, {Sys-2 (23), Sys-3 (23)}, {Sys-2 (32), Sys-3 (32)}. Wherein, each of these pairs may describe communication between two distinct user accounts and, for this embodiment, no two distinct pairs share the same dataset. Therefore, once the system resolves the pair to which the processes and/or methods of membership predicates are to be applied, such processes and/or methods may be employed, though claimed subject matter is not constrained or limited in scope to any particular approach.

In still another embodiment, pair-wise unique data sets may not be fully present in a collection of possible symbiotic partners. Therefore, in such an embodiment, multiple partial symbiotic datasets may be used for identification. This embodiment may use distribution vectors. A distribution vector, in this context, generally refers to data comprising parts which may have native data, which has been distributed to symbiotic partners via the symbiotic network. An element in the vector may comprise a one or a zero, for example, however, claimed subject matter is not limited in this respect. An element may be set to one if the symbiotic partner has a versions of the dataset. In an embodiment, for example, suppose there are four symbiotic partners on a symbiotic network: S0, S1, S2, S3—accordingly, a distribution vector may have four components. This may result in a system of vectors such as: S0(50):{1,0,1,1}; S1(s1):{1,1,0,1}; S2(s2):{1,1,1,0}; S3(s3):{0,1,1,1} describing a situation where symbiotic partner S0 may have distributed a dataset to S2 and S3 as well as maintaining a version. The data set may be called S0. S1 has a dataset called s1, which may have been distributed to S0 and S3 while maintaining a version. S2 has a data set called s2 which has been distributed to S0 and S1. S3 has distributed s3 to S1 and S2.

For the purpose of illustration, suppose that S0 would like to identify S2. There is no unique data set which may be isolated. However, S2 may be unique to S0 because it has in common with S0 datasets 50 and s2. Thus, one membership identification predicate application against 50 may narrow down the identification to the set {S1, S2}. A second membership predicate application against s2 may, in this example, narrow the possibilities down to just S2. Thus, identification in the absence of unique pairing may be achieved by performing two membership predicate applications in this example embodiment.

The foregoing may be generalized against the distribution vectors, reproduced at 610, in the following fashion. The host distribution vector, S0(S0) as described above for this example, may be written first and then below this the distribution vector for the party to be identified, S2(s2) also as described above. A logical operation, such as, for example, an AND operation here, may be performed going down the column to create a test vector, as shown at 620. For each 1 in the test vector, in this embodiment, though claimed subject matter is not limited in scope in this respect, a membership predicate may be employed. This procedure may be repeated for other members of the network producing alias vectors, as illustrated at 630 and 640, though the scope of claimed subject matter is not constrained in this regard. Pair wise comparisons of these alias vectors against a test vector may be performed, as illustrated at 650 and 660. If a test vector is a subset of an alias vector, an aliased host may be illegitimate and may be attempting to spoof a network member. In the embodiment, as illustrated at 650 and 660, for example, there can be no aliasing.

If an identification predicate fails, as in the forgoing example, one may assume a spoofing attempt. In an embodiment, it may be noted what data was used in the failed identification attempt. In the case of reverse identification predicates, an embodiment may avoid reusing this data as a spoofer may take advantage of multiple attacks to learn more about this data. Alternatively, an embodiment may purposefully reuse data that resulted in a network interloper, such as a spoofer, having failed in an attempt to connect to a system and possibly again block a similar later attempt, although the scope of claimed subject matter is not limited in this regard. Similarly, data accumulated from failed attempts to join as a symbiotic partner, regardless of whether resulting from a forward and/or reverse membership predicate, may be shared with other symbiotic partners. Therefore, and without limitation, a failed attempt as a symbiotic partner may result in more careful evaluation of partners or result in a response, such as a report or an alarm, for example, to other partners.

In the preceding description, various aspects of claimed subject matter have been described. For purposes of explanation, systems and configurations were set forth to provide a thorough understanding of claimed subject matter. However, these are merely example illustrations of the above concepts wherein other illustrations may apply as well, and the scope of claimed subject matter is not limited in these respects. It should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

1. A method of authentication of membership in a symbiotic network comprising:
requesting data derived at least in part from a data set at least partially resident on at least one external source;
receiving the requested data; and
comparing the received data with data derived at least in part from a data set resident with the requester.

2. The method of claim 1, wherein the received data comprises expected data.

3. The method of claim 2, wherein said expected data comprises valid data.

4. The method of claim 3, wherein said expected data comprises results of applying a mathematical and/or logical function.

5. The method of claim 2, wherein said applying a mathematical and/or logical function comprises at least one of a cyclic redundancy check and/or a hashing function.

6. The method of claim 1, and further comprising, prior to said requesting data, receiving from said at least one external source a request for authentication as a member of the symbiotic network.

7. An apparatus comprising: a computing platform, said computing platform comprising a member of a symbiotic network, said member adapted to authenticate membership of an external source in the symbiotic network.

8. The apparatus of claim 7, wherein said member comprises a virtual machine operable on said computing platform.

9. The apparatus of claim 7, wherein said external source comprises a virtual machine.

10. The apparatus of claim 9, wherein said virtual machine is operable on an external computing platform.

11. A method of verifying a device as a symbiotic partner comprising:
transmitting a symbiotic challenge; and
receiving one or more responses.

12. The method of claim 11, wherein said transmitting comprises transmitting to an external device; and wherein said receiving comprises receiving at a remote device.

13. The method of claim 11, and further comprising evaluating said response.

14. The method of claim 13, and further comprising determining if said response include proper form and/or proper content.

15. The method of claim 13, and further comprising;
determining a next action based at least in part upon evaluating said response.

16. The method of claim 15, wherein said next action further comprises authenticating symbiotic partnership.

17. The method of claim 15, wherein said next action further comprises authenticating symbiotic membership.

18. The method of claim 15, wherein said next action further comprises withholding symbiotic partnership.

19. The method of claim 15, wherein said next action further comprises withholding symbiotic membership.

20. The method of claim 11, wherein said symbiotic challenge further comprises generating a forward predicate.

21. The method of claim 20, wherein said forward predicate further comprises selecting at least one dataset.

22. The method of claim 21, wherein said selecting comprises choosing a dataset of a member of a symbiotic network.

23. The method of claim 22, wherein said dataset comprises an at least partial symbiotic dataset.

24. The method of claim 23, wherein said at least partially symbiotic dataset comprise a full symbiotic data.

25. The method of claim 21, wherein said selecting further comprises selecting at least one element from said dataset.

26. The method of claim 21, wherein said selecting further comprises selecting at least one element not from said dataset.

27. The method of claim 20, wherein said forward predicate further comprises receiving an expected result from said computing platform requesting authentication as a symbiotic partner.

28. The method of claim 20, wherein said forward predicate further comprises requesting an expected result from said computing platform requesting authentication as a symbiotic partner.

29. The method of claim 27, wherein said expected result comprises data resident on said computing platform.

30. The method of claim 11, wherein said symbiotic challenge further comprises a reverse predicate.

31. The method of claim 30, wherein said symbiotic challenge comprises posing a query having only one of two outcomes.

32. The method of claim 30, wherein said reverse predicate further comprises selecting at least one symbiotic dataset.

33. The method of claim 30, wherein said selecting further comprises selecting at least one element from said symbiotic dataset.

34. The method of claim 31, wherein said selecting further comprises selecting at least one element omitted from said symbiotic dataset.

35. The method of claim 11, wherein said transmitting a symbiotic challenge further comprises transmitting to a purported symbiotic partner.

36. The method of claim 25, wherein said purported symbiotic partner further comprises an implied user account.

37. The method of claim 11, wherein prior to transmitting said symbiotic challenge receiving a request for authentication as a symbiotic partner.

38. A method of claim 11, wherein said symbiotic challenge comprises forming a query based at least in part upon a dataset.

39. The method of claim 38, wherein said forming a question further comprises:
selecting at least one symbiotic dataset.

40. An apparatus comprising: means for determining a computing platform as either a member of a symbiotic network or as omitted from said symbiotic network; wherein said means for determining includes:
means for forming a challenge based at least in part on a dataset;
means for transmitting said challenge; and
means for receiving at least one response to said challenge.

41. The apparatus of claim 40, and further comprising means for evaluating said response.

42. The apparatus of claim 41, and further comprising means for selecting a next action based at least in part on evaluating said at least one said response.

43. An article comprising: a storage medium having thereon instructions, said instructions, if executed, resulting in:
forming a challenge based at least in part on a dataset;
transmitting said challenge; and
receiving at least one response to said challenge.

44. The article of claim 43, wherein said instructions, if executed, further result in: evaluating said response.

45. The article of claim 44, wherein said instructions, if executed, further result in: determining a next action base at least in part on evaluating said response.

46. The article of claim 45, wherein said instructions, if executed, further result in: authenticating a computing platform as a member of said symbiotic network.

47. The article of claim. 45, wherein said instructions, if executed, further result in: identifying a computing platform as omitted from said symbiotic network.

48. A method of successive symbiotic identification, comprising:
receiving a request to be identified as a symbiotic partner;
performing a membership predicate.

49. The method of claim 48, and further comprising:
performing a subsequent membership predicate.

50. The method of claim 48, further comprising:
performing a logical operation between a host distribution vector and a distribution vector for a party to be identified.
